(19) United States
(12) Patent Application Publication
(10) Pub. No.: US 2026/0320996 A1
(43) Pub. Date: Oct. 15, 2026

(54) IMAGE CLASSIFICATION APPARATUS, IMAGE CLASSIFICATION METHOD, AND COMPUTER-READABLE, NON-TRANSITORY RECORDING MEDIUM STORING IMAGE CLASSIFICATION PROGRAM

(71) Applicant: JVCKENWOOD Corporation, Yokohama-shi (JP)

(72) Inventor: Shingo KIDA, Yokohama-shi (JP)

(21) Appl. No.: 19/314,353

(22) Filed: Aug. 29, 2025

(30) Foreign Application Priority Data
Sep. 6, 2024 (JP) 2024-153811

(51) Int. Cl. G06V 10/86; G06V 10/74; G06V 10/764

(52) U.S. Cl. CPC G06V 10/86; G06V 10/761; G06V 10/764

(57) ABSTRACT

An associative label extraction unit extracts, from an associative knowledge graph, associative labels associable with a truth label of a primary object in an image. An embedded representation vector calculation unit determines embedded representation vectors of the associative labels, determines and averages embedded representation vectors of peripheral labels obtained from the image in relation to the truth label of the primary object. A similarity calculation unit determines a cosine similarity of the embedded representation vectors between each associative label and an averaged peripheral label. An associative label selection unit selects an associative label having a high similarity to the average peripheral label. A peripheral label expansion unit generates a cell graph with the primary object as a center node and a peripheral label as a side node, by using the selected associative label as the peripheral label and builds an image knowledge graph from the cell graph of the image.

### CROSS REFERENCE TO RELATED APPLICATION

This application claims the benefit of priority from the prior Japanese Patent Application No.2024-153811, filed on September 6, 2024, the entire content of which is incorporated herein by reference.

### BACKGROUND

### 1. Technical Field

The present disclosure relates to image classification technology.

### 2. Description of the Related Art

Humans are able to learn the characteristics of objects and the relationship that holds between the objects and to classify images accordingly. In order to apply this biological concept to establish potential associations between objects, an image knowledge graph has been proposed (Non-Patent Literature 1, Non-Patent Literature 2). By utilizing the image knowledge graph, it is possible to improve the accuracy of classification of images by considering associations between objects.

Non-patent Literature 1 Zhang, Dehai, et al. "Knowledge graph-based image classification refinement." IEEE Access 7 (2019): 57678-57690.

Non-patent Literature 2 Liu, Chunhua, Trevor Cohn, and Lea Frermann. "Commonsense knowledge in word associations and ConceptNet." arXiv preprint arXiv: 2109.09309 (2021).

However, there is a problem in image classification using an image knowledge graph in that the accuracy of classification of subjects in the image is low when there are few background objects in the image and necessary associations are missing.

### SUMMARY

An image classification apparatus according to an embodiment of the present disclosure includes: an associative label extraction unit that extracts, from an associative knowledge graph, a plurality of associative labels associable with a truth label of a primary object in an image; an embedded representation vector calculation unit that determines embedded representation vectors of the plurality of associative labels, determines embedded representation vectors of a plurality of peripheral labels obtained from the image in relation to the truth label of the primary object, and averages the embedded representation vectors of the plurality of peripheral labels; a similarity calculation unit that determines a cosine similarity between the embedded representation vector of each associative label and the embedded representation vector of an averaged peripheral label; an associative label selection unit that selects an associative label whose embedded representation vector has a high similarity to the embedded representation vector of the average peripheral label; a peripheral label expansion unit that generates a cell graph with the primary object as a center node and a peripheral label as a side node, by using the selected associative label as the peripheral label, and builds an image knowledge graph from the cell graph of the image; and a classification unit that classifies the primary object in the image by using the image knowledge graph.

Another embodiment of the present disclosure relates to an image classification method. The method includes: extracting, from an associative knowledge graph, a plurality of associative labels associable with a truth label of a primary object in an image; determining embedded representation vectors of the plurality of associative labels, determining embedded representation vectors of a plurality of peripheral labels obtained from the image in relation to the truth label of the primary object, and averaging the embedded representation vectors of the plurality of peripheral labels; determining a cosine similarity between the embedded representation vector of each associative label and the embedded representation vector of an averaged peripheral label; selecting an associative label whose embedded representation vector has a high similarity to the embedded representation vector of the average peripheral label; generating a cell graph with the primary object as a center node and a peripheral label as a side node, by using the selected associative label as the peripheral label, and building an image knowledge graph from the cell graph of the image; and classifying the primary object in the image by using the image knowledge graph.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

The disclosure will be described with reference to the following drawings.

FIG. 1 shows an image classification apparatus according to embodiment 1;

FIGS. 2A and 2B illustrate expansion of the cell graph;

FIG. 3 is a flowchart showing the steps of image classification performed by the image classification apparatus according to embodiment 1;

FIG. 4 illustrates a cell graph expanded by the peripheral label expansion unit of embodiment 2; and

FIG. 5 is a flowchart showing the steps of image classification performed by the image classification apparatus according to embodiment 2.

### DETAILED DESCRIPTION

The invention will now be described by reference to the preferred embodiments. This does not intend to limit the scope of the present invention, but to exemplify the invention.

With reference to Non-Patent Literature 1, an image knowledge graph that is a prerequisite technology will be described.

Biological concepts are important in image processing. Not only does 80% or more of the information humans receive come from our visual systems, but the human visual system also has fast, accurate, and efficient image processing capabilities. In the current image classification task, a convolutional neural network (CNN) often focuses on pixel processing and ignores semantic relationships and mechanisms of the human brain.

With the development of image analysis and processing technologies, the information in images is becoming more and more complex. Humans are able to learn the characteristics of objects and the relationship that holds between the objects and to classify images accordingly. The main concerns are how to make good use of the semantic relationship between categories and how to apply the knowledge of biological vision to image classification. In this way of thinking, we propose a concept of an image knowledge graph (IKG) that incorporates semantic association and scene association in order to fully take into account the relationship between objects (external and internal).

The image knowledge graph utilizes an inference model of a knowledge graph, which is close to the biological visual information processing model. The following four steps are taken to establish a potential association between objects:
(1) Image category extraction
(2) Establishment of scene (logical) association and semantic association
(3) Building of image knowledge graph
(4) Refinement of image classification

(1) Image category extraction

First, associated (relevant) categories are extracted. Associated categories are extracted from CNN prediction. Each category is a node in the image knowledge graph.

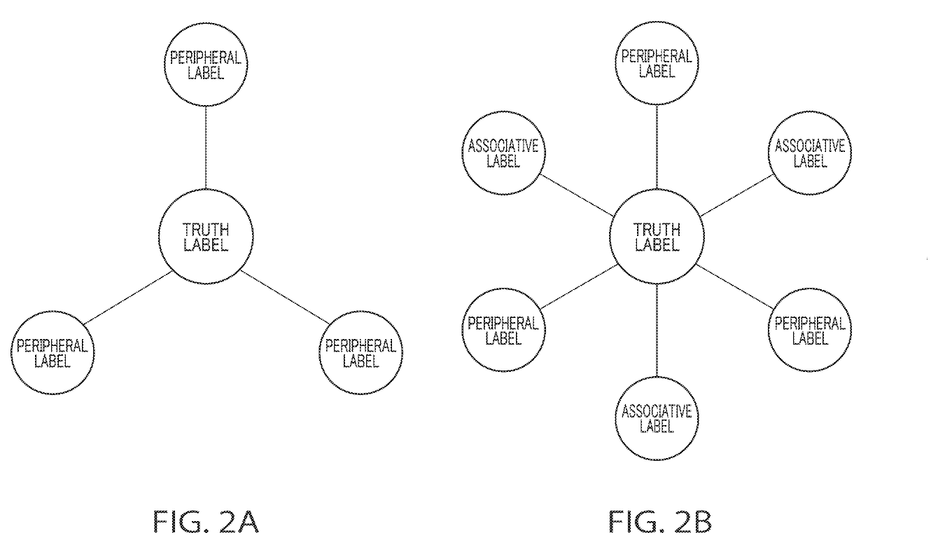

For example, associated categories relevant to two categories, computer and television set, are extracted from a large number of images of a computer and a large number of images of a television set. Background information in an image of a computer includes a keyboard, a mouse, a computer desk, a web page, etc. Background information in an image of a TV set includes a remote controller, a sofa, a living room, children, etc. By comparing such background information, a computer and a television set can be discriminated from each other (see FIG. 2 in Non-Patent Literature 1).

Objects in the image can be associated by taking into account these categories of the background.

(2) Establishment of scene association and semantic association

The relationships between categories are then divided into two types of association depending on the situation. One is semantic (semasiological) association, and the other is scene (logical) association.

Semantic association is association based on semantic similarity. For example, tigers and cats are highly similar because they belong to the same feline family, but cats and tables have little similarity, and so tigers and cats are associated by semantic association.

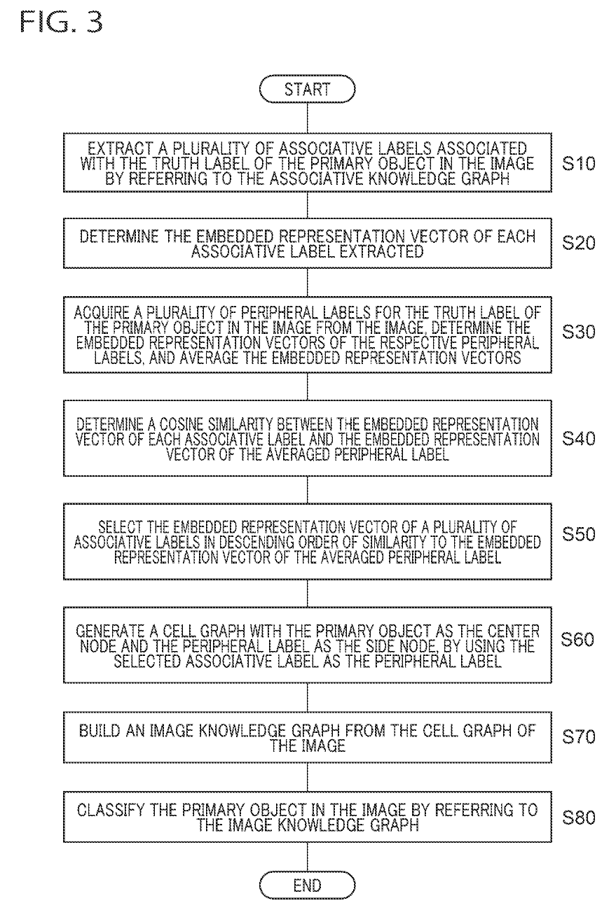

Scene association evaluates similarity with reference to the environment in which the object is located. For example, a cat and a table, a dog and a frisbee are associated in a scene in an image. In this way, a primary object in the scene and an associated peripheral object are associated (see FIG. 3 in Non-Patent Literature 1).

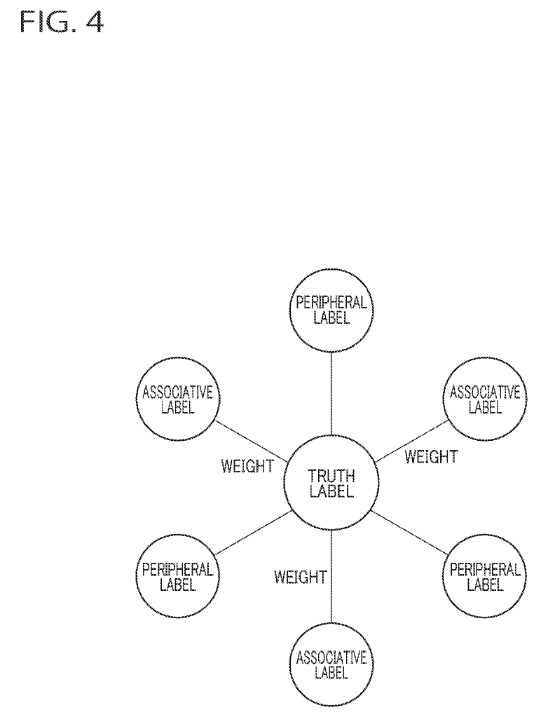

An image knowledge graph is built by integrating the semantic association and the scene association (see FIG. 4 in Non-Patent Literature 1). By using an image knowledge graph, it is possible to improve the recognition accuracy by using background information when identifying an object in the image.

(3) Building of image knowledge graph

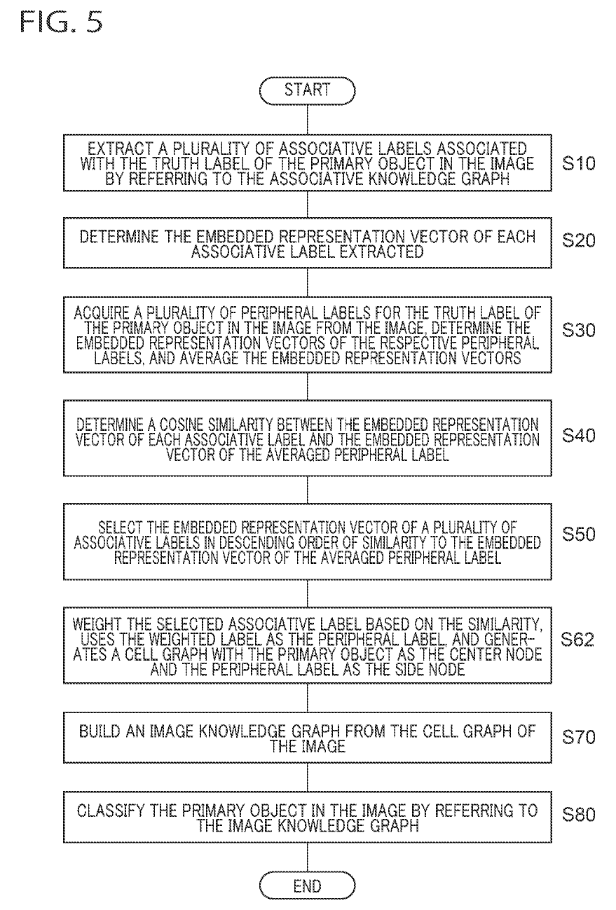

The result of CNN prediction is then combined with node and edge information to build a global image knowledge graph (see FIG. 5 in Non-Patent Literature 1).

There are four steps to build a graph.
(i) Acquire prediction labels from the image and divide them into truth labels and peripheral labels.
(ii) Build a cell graph with the truth label as the center node and the peripheral label the side node.
(iii) Merge all relevant cell graphs into a subgraph. Each subgraph is the main category.
(iv) Combine all subgraphs to build a global graph; The global graph contains knowledge information (weights) related to objects and associations between objects.

(4) Refinement of image classification

Finally, an image knowledge graph is used as additional information in image classification. Image classification is refined by using two methods. One is to use external knowledge (such as WordNet semantic web) directly, and the other is to use the image knowledge graph.

In the refinement process, each predicted label has a weight acquired from the image knowledge graph and the word corpus. A complete connection calculation is then performed for all top-10 labels. Finally, the label with the highest average correlation with each predicted label is defined as top-1. The predicted label for a single image is taken from the CNN model. The confidence value of each label is the weight of the label and is combined with the association weight acquired from the knowledge graph or the word corpus (see FIG. 6 in Non-Patent Literature 1).

In an experimental example in which an object in an image is classified by using the above-described prerequisite technology, there is a problem in that the correct label of the object cannot be predicted, and the failure rate of refinement of image classification is high in the case there are few background objects in the image and necessary associations are missing (see FIG. 13 in Non-Patent Literature 1).

Embodiments of the present disclosure will now be described. The image classification technology of the embodiment can improve the classification accuracy by supplementing relevant information when there are few background objects in the image.

### Embodiment 1

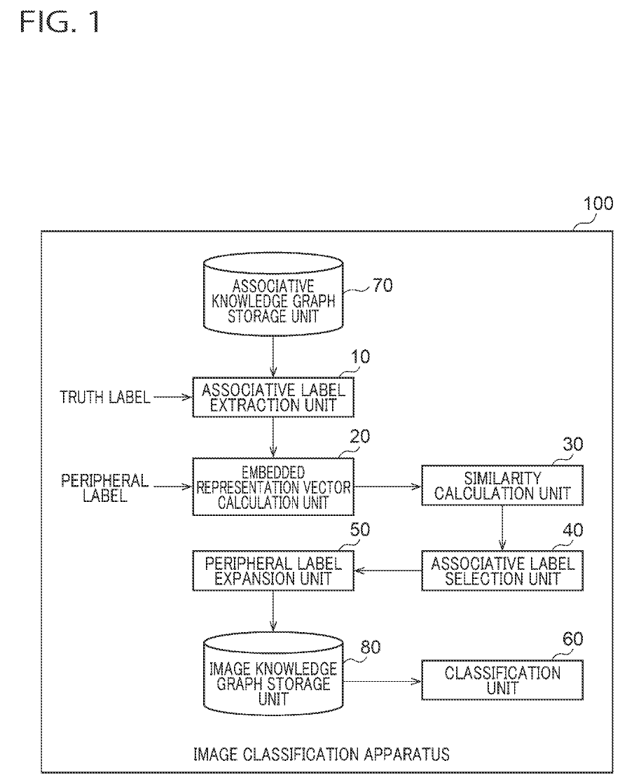

FIG. 1 shows a configuration of the image classification apparatus 100 according to embodiment 1. The image classification apparatus 100 includes an associative label extraction unit 10, an embedded representation vector calculation unit 20, a similarity calculation unit 30, an associative label selection unit 40, a peripheral label expansion unit 50, a classification unit 60, an associative knowledge graph storage unit 70, and an image knowledge graph storage unit 80.

The associative knowledge graph storage unit 70 stores an associative knowledge graphs between words. SWOW (Small World of Words), an example of an associative knowledge graph, is a knowledge graph obtained from crowdsourced word associations and is a dataset of English word associations. An associative knowledge graph can be generated by, for example, associating a word (e.g., "hiking", "nature", etc.) spontaneously generated by a human being when a cue word (e.g., "camp") is presented (see FIG. 1 in Non-Patent Literature 2).

Conventionally, there has been a problem in that necessary associations are missing and the classification accuracy is low in the case the background information in the image is poor and peripheral labels for a primary object (truth label) are few. The image classification apparatus 100 uses the associative knowledge graph to expand information highly associated with the primary object (truth label) by association.

The associative label extraction unit 10 extracts a plurality of associative labels associable with a primary object (truth label) from the associative knowledge graph.

The embedded representation vector calculation unit 20 determines an embedded representation vector for all associative labels extracted. Further, the embedded representation vector calculation unit 20 determines and averages embedded representation vectors for all peripheral labels obtained from the image in relation to the primary object (truth label).

The similarity calculation unit 30 determines a cosine similarity between the embedded representation vector of each associative label and the embedded representation vector of the averaged peripheral label.

The associative label selection unit 40 selects top several embedded representation vectors of the associative labels having a high similarity with the embedded representation vector of the averaged peripheral label.

The peripheral label expansion unit 50 generates a cell graph with the primary object as the center node and the peripheral label as the side node, by using the selected top several associative labels as peripheral labels. The peripheral label expansion unit 50 builds an image knowledge graph from the cell graph of the image and stores the image knowledge graph in the image knowledge graph storage unit 80.

The classification unit 60 classifies and labels the primary object in the image by using the image knowledge graph stored in the image knowledge graph storage unit 80.

FIGS. 2A and 2B illustrate expansion of the cell graph.

FIG. 2A is a cell graph generated by acquiring peripheral labels from the background information in the image. In the case peripheral labels are associated with the primary object (truth label), but the background information in the image is poor, the number of peripheral labels is small.

FIG. 2B is a cell graph expanded by the peripheral label expansion unit 50. By selecting an associative label having a high similarity to the peripheral label and using the selected peripheral label as a peripheral label, the peripheral labels are expanded, so that the number of peripheral labels for the primary object (truth label) increases.

FIG. 3 is a flowchart showing the steps of image classification performed by the image classification apparatus 100 according to embodiment 1.

The associative label extraction unit 10 extracts a plurality of associative labels associable with the truth label of the primary object in the image by referring to the associative knowledge graph stored in the associative knowledge graph storage unit 70 (S10).

The embedded representation vector calculation unit 20 determines the embedded representation vector of each associative label extracted (S20). The embedded representation vector calculation unit 20 acquires, from the image, a plurality of peripheral labels for the truth label of the primary object in the image, determines the embedded representation vectors of the respective peripheral labels, and averages the embedded representation vectors (S30).

The similarity calculation unit 30 determines a cosine similarity between the embedded representation vector of each associative label and the embedded representation vector of the averaged peripheral label (S40).

The associative label selection unit 40 selects the embedded representation vectors of a plurality of associative labels in descending order of similarity to the embedded representation vector of the averaged peripheral label (S50).

The peripheral label setting unit 50 generates a cell graph with the primary object as the center node and the peripheral label as the side node, by using the selected associative label as the peripheral label (S60). The peripheral label setting unit 50 builds an image knowledge graph from the cell graph of the image and stores the image knowledge graph in the image knowledge graph storage unit 80 (S70).

The classification unit 60 classifies the primary object in the image by referring to the image knowledge graph stored in the image knowledge graph storage unit 80 (S80).

### Embodiment 2

The image classification apparatus 100 according to embodiment 2 includes the same features as the image classification apparatus 100 according to embodiment 1, but the operation of the peripheral label expansion unit 50 differs from that of embodiment 1. Only the differences will be described here.

The peripheral label expansion unit 50 incorporates and integrates the selected associative label into the image knowledge graph to define association. In that process, a similarity value calculated by the similarity calculation unit 30 is used as the knowledge information (weight) related to the association between objects. Furthermore, the reliability of associative information is lower than that of scene association (factual information contained in the image) so that the weight of the associative information is configured to be relatively small.

Specifically, the peripheral label expansion unit 50 weights the top several highly similar associative labels selected by the associative label selection unit 40 based on the similarity, uses the weighted labels as peripheral labels, generates a cell graph in which the peripheral labels are connected to the primary object, and builds an image knowledge graph from the cell graph.

FIG. 4 illustrates a cell graph expanded by the peripheral label expansion unit 50 of embodiment 2. In the cell graph, the weight of an edge connecting the primary object and the associative label is set based on the similarity.

In the cell graph, the weight of the edge of the associative label is configured to be smaller than the weight of the edge of the peripheral label. This is because the peripheral label is obtained from the factual information contained in the image and is highly reliable, while the associative label is obtained from the associative information of the associative knowledge graph and so is less reliable.

Further, it is ensured that, between associative labels, the higher the similarity to the peripheral label, the greater the weight of the edge of the associative label. This is because the higher the similarity to the peripheral label, the higher the reliability.

FIG. 5 is a flowchart showing the steps of image classification performed by the image classification apparatus 100 according to embodiment 2. Steps S10, S20, S30, S40, S50, S70, S80 of image classification performed by the image classification apparatus 100 according to embodiment 2 are the same as S10, S20, S30, S40, S50, S70, S80 of image classification performed by the image classification apparatus 100 according to embodiment 1 of FIG. 3. The only difference is that step S60 of the image classification apparatus 100 according to embodiment 1 is replaced by step S62 in image classification performed by the image classification apparatus according to embodiment 2. A description of the same steps is omitted, and only step S62 that differs will be described.

The peripheral label setting unit 50 weighs the selected associative label based on the similarity, uses the weighted label as the peripheral label, and generates a cell graph with the primary object as the center node and the peripheral label as the side node (S62). It is preferable that, between associative labels in the cell graph, the higher the similarity to the peripheral label, the greater the weight of the edge of the associative label set by the peripheral label setting unit 50, and that the weight of the edge of associative label is configured to be smaller than the weight of the edge of the peripheral label set by the peripheral label setting unit 50.

According to the image classification apparatus 100 of embodiments 1, 2, the accuracy of classification of the primary object can be improved by expanding the information highly associated with the primary object in the image by association. According to the image classification apparatus 100 of embodiment 2, associative information can be weighted based on the reliability of the associative information and associated with the primary object in the image.

The above-described various processes in the image classification apparatus 100 can of course be implemented by hardware-based apparatuses such as a CPU and a memory and can also be implemented by firmware stored in a ROM (read-only memory), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Given above is a description of the present disclosure based on the embodiment. The embodiment is intended to be illustrative only and it will be understood by those skilled in the art that various modifications to combinations of constituting elements and processes are possible and that such modifications are also within the scope of the present disclosure.

What is claimed is:

1. An image classification apparatus comprising:
an associative label extraction unit that extracts, from an associative knowledge graph, a plurality of associative labels associable with a truth label of a primary object in an image;
an embedded representation vector calculation unit that determines embedded representation vectors of the plurality of associative labels, determines embedded representation vectors of a plurality of peripheral labels obtained from the image in relation to the truth label of the primary object, and averages the embedded representation vectors of the plurality of peripheral labels;
a similarity calculation unit that determines a cosine similarity between the embedded representation vector of each associative label and the embedded representation vector of an averaged peripheral label;
an associative label selection unit that selects an associative label whose embedded representation vector has a high similarity to the embedded representation vector of the average peripheral label;
a peripheral label expansion unit that generates a cell graph with the primary object as a center node and a peripheral label as a side node, by using the selected associative label as the peripheral label, and builds an image knowledge graph from the cell graph of the image; and
a classification unit that classifies the primary object in the image by using the image knowledge graph.

2. The image classification apparatus according to claim 1,
wherein the peripheral label expansion unit weights a highly similar associative label selected by the associative label selection unit based on the similarity and uses the weighted label as the peripheral label and generates a cell graph in which the peripheral label is connected to the primary object.

3. The image classification apparatus according to claim 2,
wherein the peripheral label expansion unit configures a weight of an edge of the associative label to be smaller than a weight of the peripheral label in the cell graph.

4. An image classification method comprising:
extracting, from an associative knowledge graph, a plurality of associative labels associable with a truth label of a primary object in an image;
determining embedded representation vectors of the plurality of associative labels, determining embedded representation vectors of a plurality of peripheral labels obtained from the image in relation to the truth label of the primary object, and averaging the embedded representation vectors of the plurality of peripheral labels;
determining a cosine similarity between the embedded representation vector of each associative label and the embedded representation vector of an averaged peripheral label;
selecting the embedded representation vector of the associative label having a high similarity to the embedded representation vector of the average peripheral label;
generating a cell graph with the primary object as a center node and a peripheral label as a side node, by using the selected associative label as the peripheral label, and building an image knowledge graph from the cell graph of the image; and
classifying the primary object in the image by using the image knowledge graph.

5. A non-transitory computer-readable recording medium storing an image classification program comprising computer-implemented modules including:
a module that extracts, from an associative knowledge graph, a plurality of associative labels associable with a truth label of a primary object in an image;
a module that determines embedded representation vectors of the plurality of associative labels, determines embedded representation vectors of a plurality of peripheral labels obtained from the image in relation to the truth label of the primary object, and averages the embedded representation vectors of the plurality of peripheral labels;
a module that determines a cosine similarity between the embedded representation vector of each associative label and the embedded representation vector of an averaged peripheral label;
a module that selects the embedded representation vector of the associative label having a high similarity to the embedded representation vector of the average peripheral label;
a module that generates a cell graph with the primary object as a center node and a peripheral label as a side node, by using the selected associative label as the peripheral label, and builds an image knowledge graph from the cell graph of the image; and
a module that classifies the primary object in the image by using the image knowledge graph.
